(19) United States
(12) Patent Application Publication
(10) Pub. No.: US 2013/0157730 A1
(43) Pub. Date: Jun. 20, 2013

(54) Protective Phone Case

(71) Applicant: Mobile Togs, LLC, Shaker Heights, OH (US)

(72) Inventors: John A. McCormac, Shaker Heights, OH (US); Fredrich H. Dengel, Avon, OH (US); Jiju G. Johnson, Waukesha, WI (US)

(73) Assignee: MOBILE TOGS, LLC, Shaker Heights, OH (US)

(21) Appl. No.: 13/674,795

(22) Filed: Nov. 12, 2012

Related U.S. Application Data
(60) Provisional application No. 61/558,426, filed on Nov. 10, 2011.

(51) Int. Cl. H04W 88/02

(52) U.S. Cl. CPC H04W 88/02
USPC 455/575.8

(57) ABSTRACT

A protective phone case for a cellular phone having a back surface with an external surface supporting a reflective material such as a mirror, the back surface further including a notch shaped cut-out forming and providing access to an opening for receiving credit cards or other flat elongate objects between the back surface of the cellular phone and an internal surface of the protective phone case.

### CROSS REFERENCE TO RELATED APPLICATIONS

The present application claims priority from U.S. Patent Application No. 61/558,426 filed Nov. 10, 2011, the entire disclosure of which is incorporated herein by reference.

### TECHNICAL FIELD

The present application is directed to a phone case for protecting a cellular telephone which also includes a mirror and an opening or slot for receiving cards, such as credit cards or business cards.

### BACKGROUND

As the use of cellular telephones continues to increase, likewise the need for a protective case to surround and protect the expensive device as it is carried and used throughout the day during a variety of user activities has increased. While for some, their cellular phone may be conveniently carried in a bag, backpack or purse, for others, carrying an additional bag is not desirable. As a result, a phone case may be desired not only for the purpose of protecting the cellular phone, but also for providing a carrying container for a minimal number of important items, such as such as a driver's license, credit card or paper money. Also, the use of a mirror securely mounted to the protective phone case can be useful and convenient.

### SUMMARY

The phone case of the present application includes a mirrored or reflective material back surface. As shown, the mirror may be uncovered, or in an alternate embodiment, it may be covered by a movable flap. The mirror may be made of any reflective material, such as plastic, metal or glass. An opening or card slot is also provided with a notch for thumb or finger access to the cards. The slot may hold a single or multiple cards, such as a laminated driver's license, credit cards or folded paper money, behind the back surface of the phone case supporting the mirror. An eyelet and/or clasp may be present for attaching a lanyard to enable attachment of the phone case supporting the phone to another item, such as a jacket, backpack or purse, for example.

In still another alternate embodiment, the structure supporting the mirror and card slot may be provided in a stand alone condition, without a dedicated phone case, but provided in a manner so that the contained unit may be applied to the back of any phone with adhesive material.

### BRIEF DESCRIPTION OF DRAWINGS

The attached figures illustrate embodiments of the tool of the present application.

FIG. 1 is a perspective view of the improved protective phone case;

FIG. 2 is a rear view showing the mirror of the phone case of FIG. 1;

FIG. 3 is a top view of the phone case of FIG. 1;

FIG. 4 is a bottom view of the phone case of FIG. 1;

FIG. 5 is a front view of the phone case of FIG. 1;

FIG. 6 is a right side view of the phone case of FIG. 1;

FIG. 7 is a left side view of the phone case of FIG. 1;

FIG. 8 is a perspective front view showing the phone case of the present application with an iPhone® style phone protected by the case;

FIG. 9 is a bottom view of the phone case of FIG. 8 showing the stops or nibs projecting upwardly from the back surface of the case into the open area of the notch, so the credit cards inserted into the slot are captured within the case by the stops once they are fully inserted;

FIG. 10 is a perspective rear view of the protective phone case of FIG. 8, showing the back surface supporting the reflective mirror;

FIG. 11 is a perspective rear view of an alternate embodiment of a phone case having multiple notches, and showing the back surface supporting the reflective mirror;

FIG. 11A is an inside perspective view of the alternate embodiment phone case of FIG. 11, showing the thickness of the slot formed between the back of the phone case supporting the reflective mirror and the phone, once inserted into the protective case;

FIG. 12 is a bottom view of the phone case of FIG. 11;

FIG. 13 shows a perspective view of the phone case of FIG. 11, but with the mirror shown with openings formed for receiving molding material to embed the mirror within the phone case;

FIG. 14 is a cut-away side view of the phone case of FIG. 13 taken along the line 14-14, and showing the molding material received within the openings formed in the mirror;

FIG. 15 is a rear view of an alternate phone case supporting a removable mirror;

FIG. 16 is a cut-away side view of the phone case of FIG. 15 taken along the line 15-15, and showing the space provided within the protective phone case for receiving the removable mirror; and

FIG. 17 is an enlarged view taken from FIG. 16 showing the engagement of the removable mirror within the protective phone case.

### DETAILED DESCRIPTION

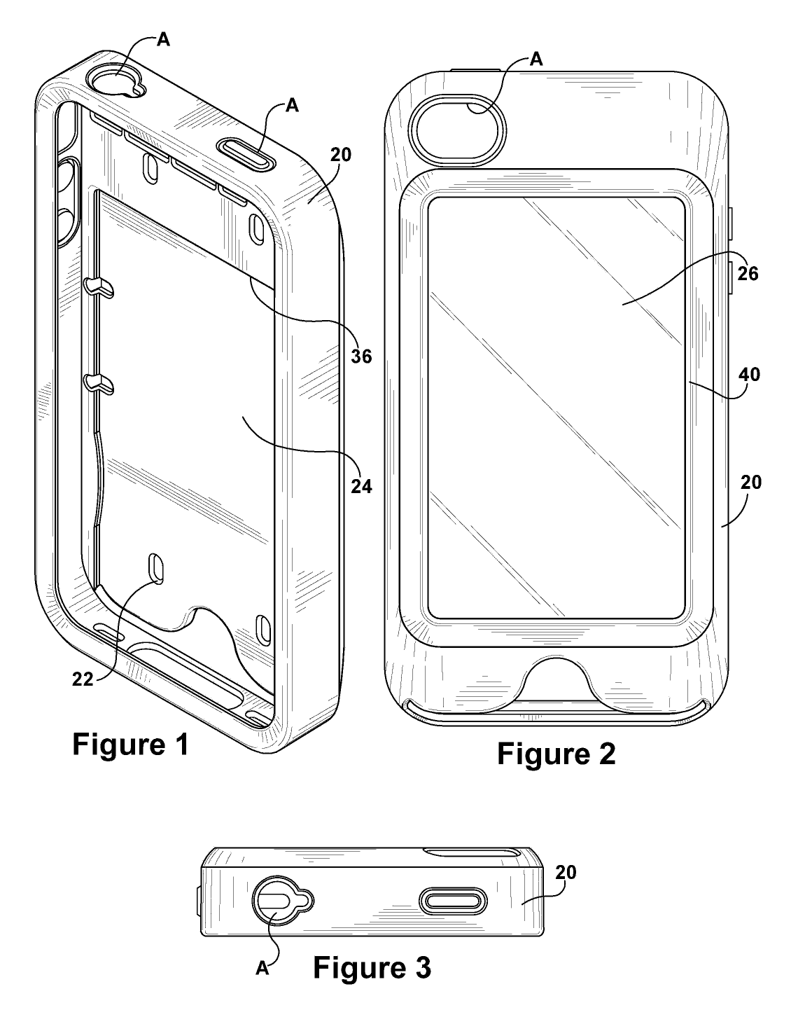

The present application is for a new and improved protective phone case 20 which may be provided of any suitable material being used for protective phone cases, such as semi-rigid, for example, polycarbonate, thermoplastic polyurethane, or flexible polymer materials, for example, silicone skin material. In the illustrated embodiments, a reflective material or a mirror is securely positioned within or on the case. As illustrated in FIG. 1, small openings 22 are provided within the internal back surface 24 of the phone case, behind the mirror of reflective material 26 supported on an external back surface 28 of the phone case. Obviously, various sized and shaped covers and openings A are also provided within the phone case 20 to enable aligned engagement with the necessary corresponding accessories, buttons and switches on the phone P when engaged within the phone case 20.

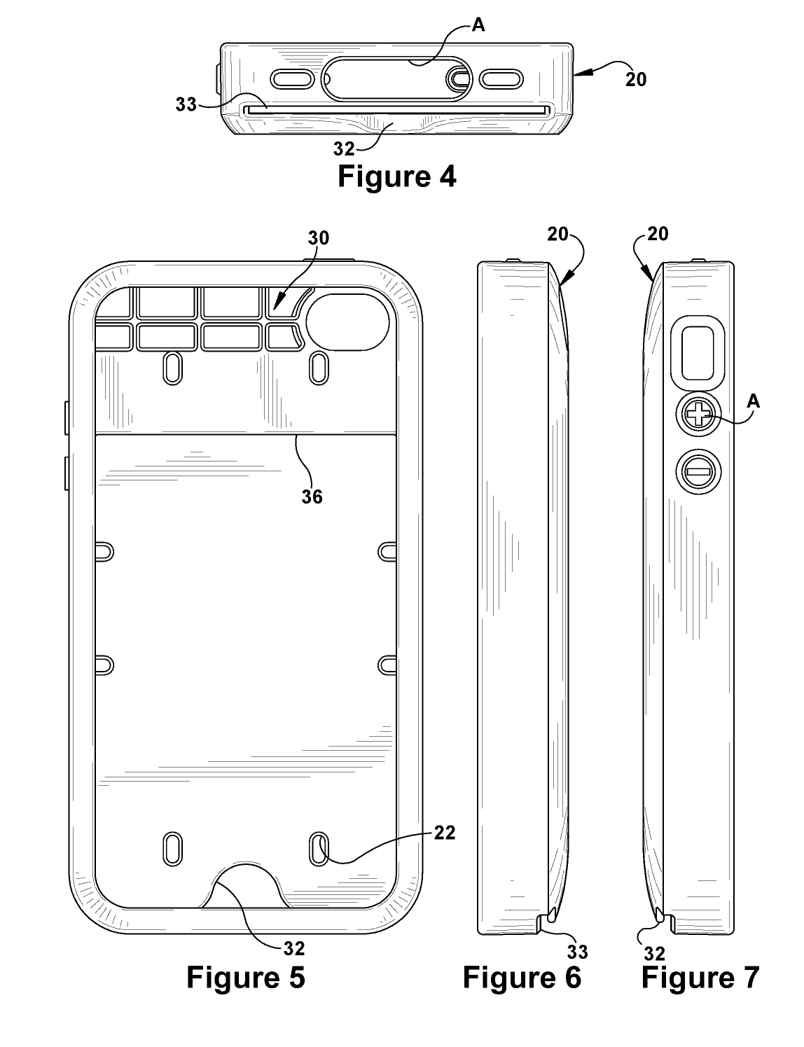

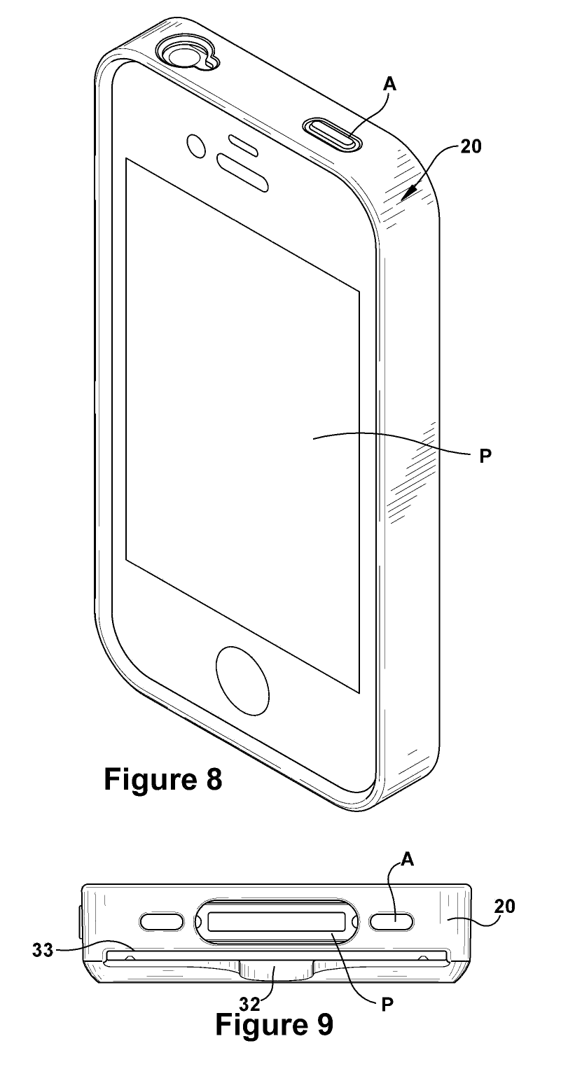

Additionally, a ribbed spacing structure 30 is provided on the alternate embodiment of FIG. 5 on the upper internal back surface of the phone case, so that the back of the phone case is slightly spaced from the back surface of the phone during engagement of the phone P within the case. The ribs and resulting spaced relationship enable formation of an internal space 31 for supporting one or more credit cards within the opening formed. The internal space is accessed through a notch 32, or the opening which appears in part similar to a bell shaped curve, a normal distribution curve or an elongate, low amplitude Gaussian waveform, with the extreme ends of the opening turned slightly upward to follow the corners of the phone case. In the embodiment of the phone case of FIGS. 1 to 10, the opposite portion 33 of the opening 32 is adjacent a bottom edge of the external surface of the back surface of the protective phone case has a substantially straight configuration. In the embodiment of the phone case of FIGS. 11, 11A and 12, an additional notch is also provided on the bottom or end surface 34.

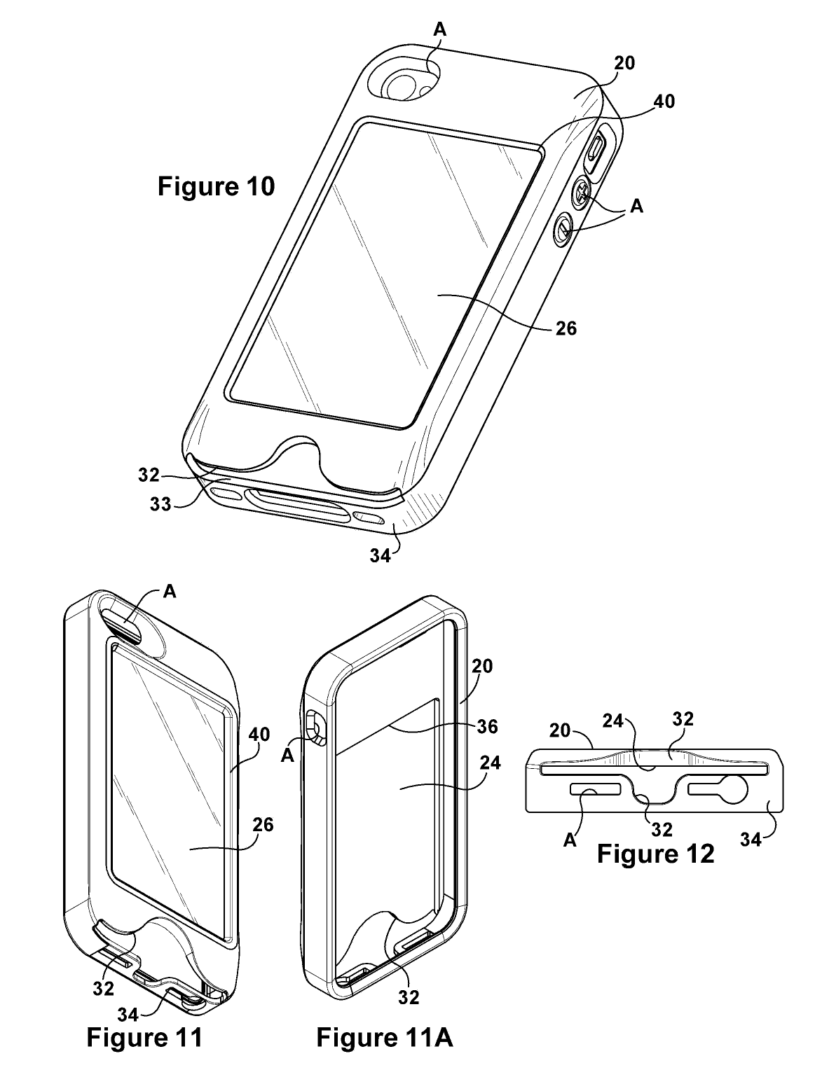

As shown in the phone case embodiments of FIGS. 10 to 12 and FIGS. 13 to 17, the slot or internal space for the credit cards, may also support any flat items, such as a driver's license or folded paper money. The notch 32 enables removal of items inserted into the internal space by sliding finger movements across the items CC exposed within the notch. As clearly shown in FIGS. 11A, 14 and 17, no ribbed structure is provided, and the internal space is provided with a thickness T of approximately 1.5 mm between the internal back surface 24 and the back of the phone once it is inserted into the case 20. A stop 36 is provided to define the internal space and prevents items inserted into the space, such as a credit card CC in FIG. 15, from traveling further into the phone case.

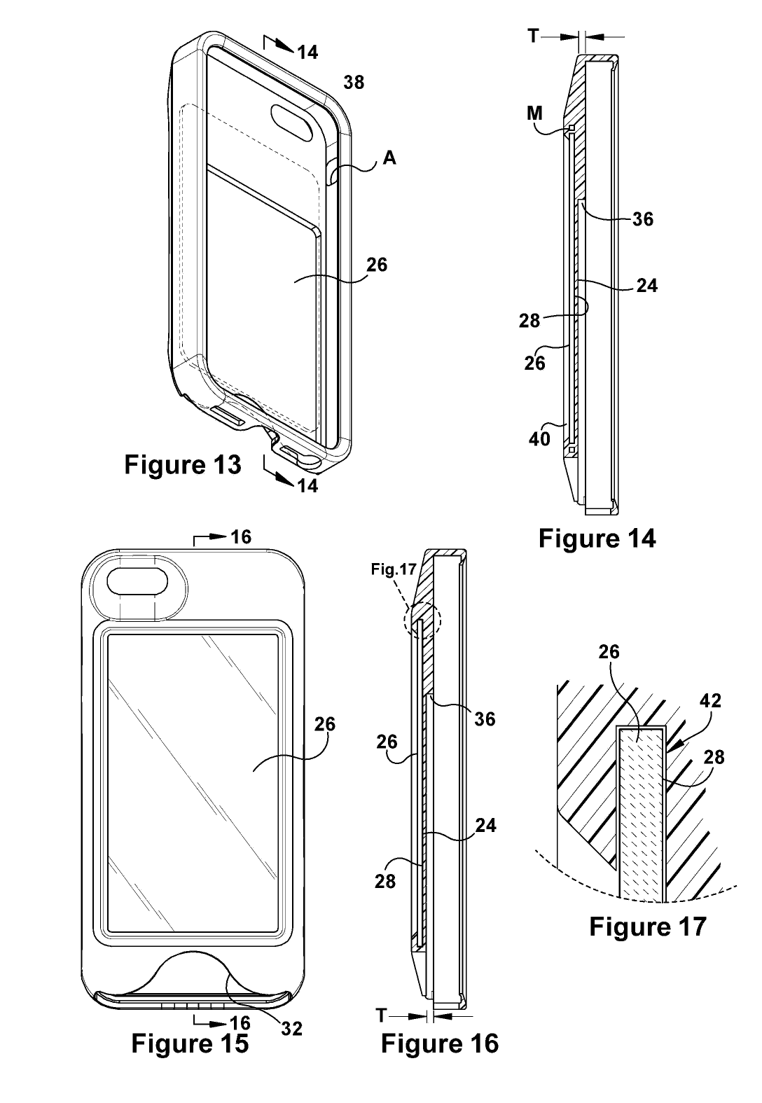

FIGS. 13 and 14 illustrate the use of a mirror 26 which is permanently molded or embedded into the protective phone case. As shown in FIG. 13, the mirror of reflective material includes openings 38 formed adjacent edge portions of the of the mirror 26, which openings are covered by a frame 40 which surrounds the mirror, once molding is complete. As shown in FIG. 14, molding material M fills into the openings 38 and forms the protective phone case to permanently secure or embed the mirror 26. Alternatively, in the embodiment of FIGS. 15-17, the mirror is not molded into position, and may be removed from the case for replacement in the event of breakage or for use of an alternative mirror having a different color or decoration. As shown in the enlarged depiction of FIG. 17, a gap 42 is provided for engagement of a mirror 26 within the case, which is more readily accomplished when the protective case is of a flexible silicone skin material.

As used in this application, the term “notch” is intended to have the broadest possible meaning, for example, and including without limitation, the following, an indentation having any shape, an indentation at the edge of a structure, an incisure, small downward deflection, a semicircular depression, a concavity in a superior surface, an upstroke or peak on a pulse tracing, and, as shown in the attached Figures, a notched cut-out adjacent a bottom edge of the external surface of the back surface of the protective phone case, where the shape of one portion of the cut-out along the back surface of the phone case in a direction away from the bottom edge has the shape of an elongate, low amplitude Gaussian waveform and the shape of another portion of the cut-out along the bottom edge may be straight or include another form of notch.

While the present mirrored, slotted protective phone case has been described with reference to certain preferred embodiments, one of ordinary skill in the art will recognize that additions, deletions, substitutions, modifications and improvements can be made while remaining within the spirit and scope of the present invention as defined by the appended claims

We claim:

1. A protective phone case for a cellular phone having a back surface with an external surface supporting a reflective material such as a mirror, the back surface further including a notch shaped cut-out forming and providing access to an opening for receiving credit cards or other flat elongate objects between the back surface of the cellular phone and an internal surface of the protective phone case.

2. A protective phone case for a cellular phone having a back surface having an external surface including a notch shaped cut-out forming an opening and providing access to an internal slot for receiving credit cards or other appropriately sized flat objects between the back surface of the cellular phone and a back surface of the protective phone case.

3. The protective phone case of claim 1, wherein the reflective material is metal.

4. The protective phone case of claim 1, wherein the reflective material is a plastic.

5. The protective phone case of claim 1, wherein the reflective material is glass.

6. The protective phone case of claim 1 or 2, wherein the notched shaped cut-out is formed adjacent a bottom edge of the external surface of the back surface of the protective phone case, and the shape of the cut-out along the back surface away from the bottom edge has the shape of an elongate, low amplitude Gaussian waveform.

7. The protective phone case of claim 2, wherein the slot formed between the back surface of the cellular phone and the internal surface of the back surface of the protective phone case has a thickness of approximately 1.5 mm.

8. The protective phone case of claim 1, wherein the mirror has at least one opening, where each opening is formed adjacent an opposing surface of the mirror, which openings receive molding material to embed the mirror in a fixed position within the protective phone case.
